(19) United States
(12) Patent Application Publication
(10) Pub. No.: US 2007/0214923 A1
(43) Pub. Date: Sep. 20, 2007

(54) Method and device for producing portions

(76) Inventor: Wilfried Maier, Diemannsried (DE)

Correspondence Address: PERMAN & GREEN, 425 POST ROAD, FAIRFIELD, CT, 06824, US

(21) Appl. No.: 10/587,616

(22) PCT Filed: Feb. 10, 2005
(86) PCT No.: PCT/EP05/01342

§ 371 Date: Jun. 13, 2007

(30) Foreign Application Priority Data
Feb. 13, 2004 (DE) 10 2004 007 492.5
Feb. 16, 2004 (DE) 10 2004 007 671.5

(51) Int. Cl. B23D 25/02

(52) U.S. Cl. 83/37; 83/932

(57) ABSTRACT

The invention relates to a method and device for producing portions of food, and also to a device for slicing food and to a method for separating slices from a block of food.

The present invention relates to a method and a device for producing portions of food products. The present invention further relates to a device for slicing food products and a method of severing food product slices from food product blocks.

These days, commercial demand is for ever thinner food product slices and a higher number of food product slices per portion supplied. For this reason, so-called “wafer-thin slicing” is performed and the resultant food-product slices are configured as desired by consumers to yield a random portion, in order on the one hand to take up less space in the packaging and on the other hand to give a loose, airy appearance. This type of presentation has the additional advantage that a larger product surface is obtained per portion size and thus as a rule the aroma of the product to be portioned is shown off to better advantage.

According to the prior art, such portions are produced by cutting slices with a blade onto a belt, laying them flat thereon and then piling them up together into a random portion. This procedure is known as “shaving” and has the disadvantage, however, that the form taken by the portion and the individual slices relative to one another cannot be controlled. A particular problem in the known prior art consists in the fact that the slices piled up together in this way overlap to a greater or lesser degree and then stick together in the packaging, such that the end user cannot easily remove an individual slice from the pile of slices.

It was therefore the object of the present invention to provide a method of producing food product portions which does not exhibit the disadvantages of the prior art.

The object is achieved according to the invention with a method according to claim 1. Preferred embodiments of the method according to the invention are claimed in subordinate claims 2 to 4.

It was extremely surprising to the person skilled in the art and not at all expected that it should be possible, with the method according to the invention, to produce piled-up portions in which the food product slices do not stick together. The appearance of the portions produced is very attractive. The method according to the invention is simple and cheap to carry out. Controlled shaving takes place.

For the purposes of the invention, a food product portion consists of slices of any desired food products. Preferably, however, it comprises sausage, ham, cheese or the like.

According to the invention, the cut-off food product slices are firstly shaped, before being deposited on a means, for example a portioning and/or conveyor belt. For the purposes of the invention, shaping is any change in the substantially flat form which the food product slice adopts after severing of the food product slice, such that the food product slice does not lie flat on the means on which it is deposited after cutting. Preferably, shaping involves fluting and/or folding of the food product slice, wherein in the case of folding the degree of overlap is freely selectable. Shaping of the food product slice, for example fluting or folding of the food product slice, may be effected for example by an air jet or a folding device, which is preferably arranged between the blade which severs the food product slices from the food product block and the means on which the shaped slice is deposited. In a preferred embodiment, the means for shaping the food product slices is one or more driven or non-driven roller(s), which are preferably arranged on a shaft. It is also preferred for the means for shaping the food product slice to comprise a device as described in EP 0 776 740, which is introduced herein by way of reference and thus constitutes part of the disclosure. The person skilled in the art will understand that shaping of the food product slice may also be effected by interplay for example between the shaping means and the means on which the food product slice is deposited.

Furthermore, according to the invention the spacing between the food-product slices is reduced after deposition thereof for example on a portioning and/or conveyor belt with which they are preferably also conveyed on further.

This reduction in spacing preferably takes place as a result of piling up of the food product slices, which is preferably achieved in that the speed of the front one of two successive food product slices is reduced, such that the rear slice is pushed against the front slice due to its greater speed.

The present invention further provides a device for producing food product portions, which comprises a means for shaping food product slices and a means for changing the spacing between the food product slices.

It was extremely surprising to the person skilled in the art and not at all expected that it should be possible, with the device according to the invention, to provide food product portions with a loose, airy appearance, in which the food product slices do not stick together. The device according to the invention is simple and economic to produce and operate.

According to the invention, the device comprises a means for shaping the food product slices. Reference is made to the above disclosure with regard to this means.

Moreover, the device according to the invention comprises a means for changing the spacing between two shaped food product slices. Reference is made to the above disclosure also with regard to this means.

In a preferred embodiment, the device according to the invention comprises a first and a second conveyor belt, which form a conveying plane. The first conveyor belt optionally assists in shaping the food product slice, which once shaped is then deposited on the first conveyor belt and transferred to the second conveyor belt. The second conveyor belt exhibits a slower conveying speed than the first conveyor belt at least to reduce the spacing between the food product slices, i.e. to effect shaving. By changing the relative speed, the shaped food product slices are pushed against one another and thereby piled up. Their mutual spacing diminishes.

In a further preferred embodiment, the first belt is arranged above the second belt, such that the shaped food product slices fall from the first belt onto the second belt. In this embodiment too, the first conveyor belt optionally contributes to shaping, for example folding, of the food product slices. The conveying speeds of the two belts is so selected, for the purpose of piling up, i.e. reducing the spacing between two food product slices, that the conveying speed of the second conveyor belt is less than the sum of the conveying speed of the first conveyor belt-plus the speed at which the food product slice falls from the first conveyor belt onto the second conveyor belt.

In another preferred embodiment, piling up of the shaped food product slices is achieved by a conveying obstacle, for example a blocking rake.

The present invention further provides a device for slicing foodstuffs, which comprises a means for changing the shape of a food product slice, at least one parameter being adjustable, wherein adjustment of the parameter(s) takes place during operation of the device, preferably during slicing.

It was extremely surprising to the person skilled in the art and not at all expected that it should be possible, with the device according to the invention, to change the shape of food product slices very effectively and simply. Since the food product blocks to be sliced sometimes change during slicing, the means for changing the shape of the food product slices may be adapted accordingly, such that the food product slices may always be formed into the same shape.

The means for changing the shape of a food product slice may be any desired means familiar to the person skilled in the art, which is arranged as a rule in the trajectory of the food product slice between the blade and a portioning or conveyor belt and with which the substantially flat shape of food product slices may be changed after severing from the food product-block. Preferably, the food product slices are fluted or folded. This means consists for example of driven or non-driven rollers, in particular trapezoidal rollers, or of driven or non-driven belts, such as are disclosed for example in EP 0 776 740 B1. Otherwise, reference is also made to the above disclosure with regard to the shaping means.

For the purposes of the invention, a parameter is for example the position of the means and—if the means comprises a drive for the rollers or the belts—the speed thereof.

Preferably, adjustment of the position of the means for shaping the food product slices is effected by a variable speed drive, wherein the respective positions may be stored in a machine program. Preferably, the change in position of the means takes place relative to the cutting plane and/or relative to the slice as it falls.

In a further preferred embodiment, the device comprises a belt, for example a conveyor or a portioning belt. With this belt, the shaped food product slices may be configured into a portion and/or conveyed away by the belt. The belt may assist the shaping means in shaping the food product slices. The belt may be raised and lowered, in order for example to produce food product stacks. Very particularly preferably, the position of the means for shaping the food product slices remains unchanged relative to this belt, i.e. there is a rigid connection between the means and the belt for at least some of the time. The change in position of the means for shaping the slices may then take place jointly with the portioning and/or conveyor belt.

It is also preferred for the device according to the invention to comprise a detecting means, with which at least one characteristic of the food product block to be sliced and/or of the cut-off food product slice may be detected. Adjustment of the parameters of the means for shaping the food product slices then takes place preferably as a function of the signal from the detecting means.

The characteristics may be any desired characteristics of the product. Preferably, however, the characteristics comprise the height of the product, the thickness of the food product, the type of food product and/or the temperature thereof.

The present invention further provides a method of severing food product slices from food product blocks, the shape of the food product slice being changed by a means after severing and at least one adjustable parameter of the means being changed during slicing of the food product block.

Preferably, the position of the means is changed relative to the cutting plane and/or relative to the slice as it falls.

Particularly preferably, a detecting means is used to determine at least one characteristic of the food product block to be sliced and/or of the cut-off food product slices and to change at least one parameter of the means as a function thereof.

The invention is explained below with reference to FIGS. 1 to 4. These explanations are given merely by way of example and do not restrict the general concept of the invention. The explanations apply equally to all the methods according to the invention and all the devices according to the invention.

FIG. 1 shows a slicing machine with a folder for food product slices

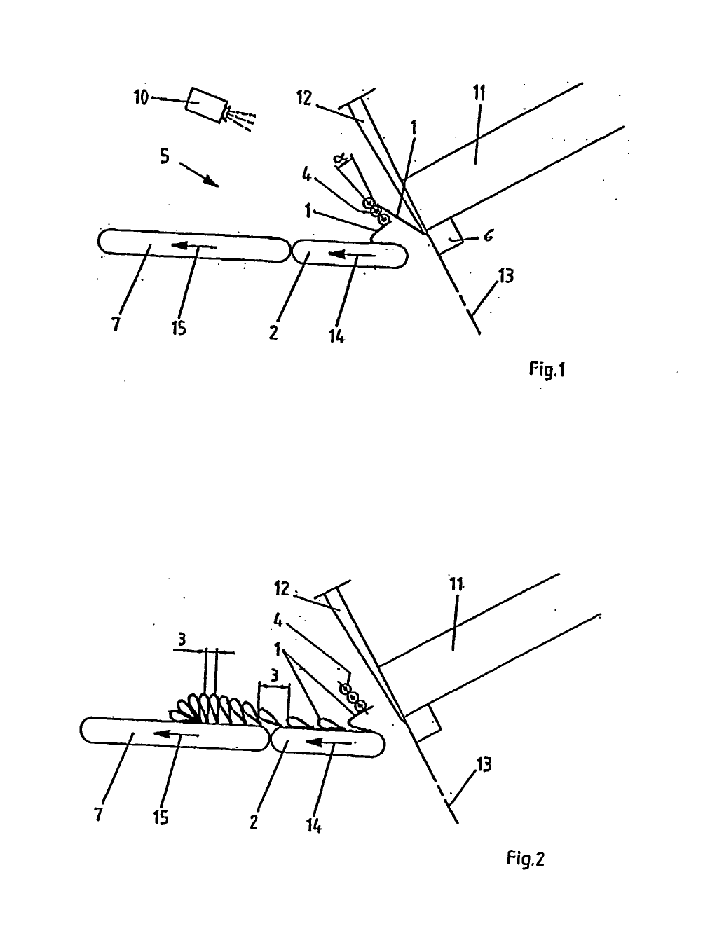

FIG. 2 shows one example of how food product slices are piled up

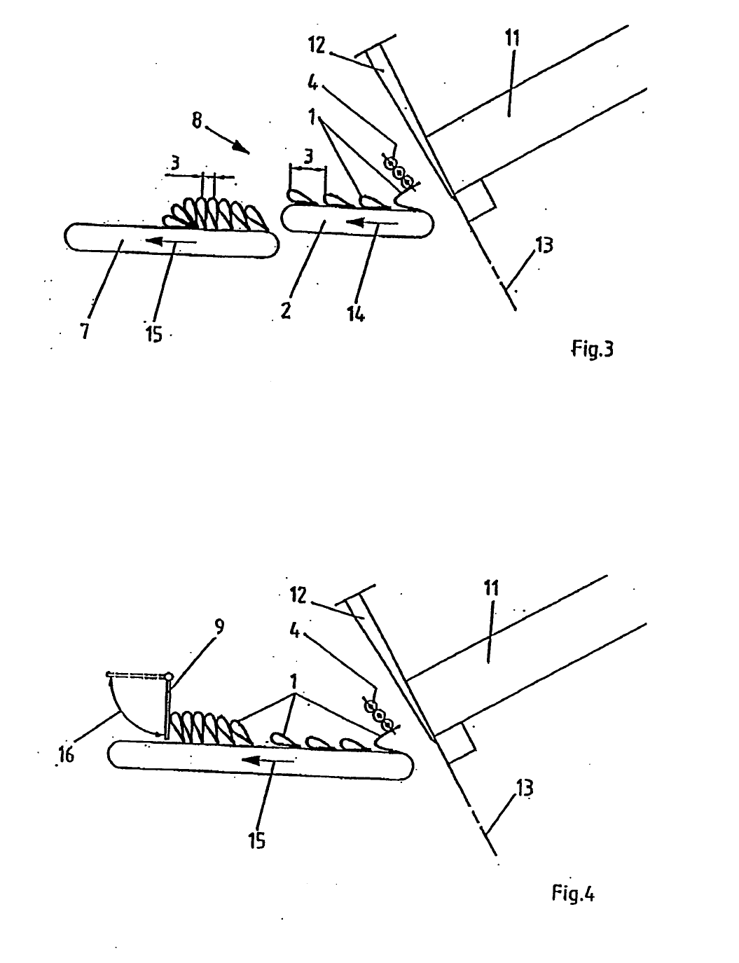

FIG. 3 shows a further example of how food product slices are piled up

FIG. 4 shows a third example of how food product slices are piled up.

FIG. 1 shows a food product slicer, in which a food product block 11 is cut into food product slices 1 by means of a blade 12. The blade 12 interacts with the cutting edge 6 and forms the cutting plane 13. The cut-off food product slices 1 fall with one end onto the folder 4 and are shaped thereby, i.e. are at least bent. The product folder 4 consists in the present case of three shafts, on which there are arranged rotatable, non-driven prismatic rollers. The non-driven prismatic rollers have the advantage that the food product slice does not enter the product folder and get caught therein. In addition, the prismatic rollers have the advantage that contact between the surfaces of food product slice and product folder is minimal, so avoiding the slice becoming stuck to the product folder. The kinetic energy of the slice as it falls is sufficient for it to achieve a folded position in controlled and defined manner after contact with the product folder. According to the invention, the product folder is so mounted that it is on the one hand freely displaceable in the plane of the paper and/or the angle a is variable. These changes take place during slicing of the food product block and in a preferred embodiment on the basis of characteristics of the cut-off food product slice 1 and/or of the food product block 11 to be sliced, said characteristics being detected by a detecting means, for example a camera 10. Such characteristics may for example be the height 17 of the food product block 11, the thickness of the slice 1, the type of food product and/or the temperature of the cut-off slice 1 or of the food product block 11. The person skilled in the art will understand that the detecting means and/or a further detecting means may also be arranged in the area of the food product block, i.e. on the other side of the blade 12. Changing the position of the product folder 4 makes it possible to achieve uniform folding even in the case of varying product parameters, wherein the degree of food product slice overlap is freely selectable. The folded, i.e. shaped, food product slice 1 is deposited on the conveyor belt 2 and conveyed at a speed V₁₄ in the direction illustrated by arrow 14 and transferred to a further conveyor belt 7, which conveys the folded food product slices at the speed V₁₅ in the direction illustrated by arrow 15. The person skilled in the art will recognise that the conveyor belt 2 may assist the product folder 4 in folding the food product slice, for example with one end 1a of the food product slice 1 already lying on the conveyor belt 2 and this end 1a of the food product slice being pushed by the conveyor belt 2 under the other end lb. The distance between the folder 4 and the conveyor belt is preferably not changed. A conveyor belt 7, which is necessary for piling up-purposes, is arranged downstream of the conveyor belt 2.

FIG. 2 shows details of folding and of the two conveyor belts 2, 7. As has already been explained, the slice 1 cut off from the food product block 11 is shaped at the product folder 4 such that it is deposited as a folded food product slice on the conveyor belt 2. The degree of folding depends inter alia on the position of the product folder 4 relative to the slice as it falls and to the cutting plane. The folded slices 1, which are spaced by a comparatively large amount 3 on the conveyor belt 2, are conveyed at the speed V₁₄ in the direction of the conveyor belt 7 and transferred thereonto. The conveyor belt 7 conveys the food product slices 1 at a speed V₁₅, which is less than the speed V₁₄, such that the food product slices are slowed down after transfer onto the conveyor belt 7 and pushed into one another, their mutual spacing being reduced. In this way, a piled-up portion is produced, in which the individual product slices lie in defined manner next to one another, however, and do not stick to one another. The consumer may remove individual slices from the portion. The person skilled in the art will recognise that the folded food product slices may also already be overlapping in part on the conveyor belt 2 and that this spacing is then further reduced on the conveyor belt 7.

FIG. 3 shows a further example of how the shaped, i.e. folded, food product slices are piled up. The shaped food product slices are conveyed by the conveyor belt 2 in the direction of the conveyor belt 7 at the speed V₁₄. The conveyor belt 2 is arranged above the conveyor belt 7 and bent over at its front end 8, such that a so-called “waterfall” is formed, over which the folded food product slices fall onto the conveyor belt 7. The food product slices are conveyed on further at the speed V₁₅ once they have fallen from the conveyor belt 2 onto the conveyor belt 7. The speed V₁₅ is selected in such a way that it is slower than the speed of the conveyor belt V₁₄ plus the speed at which the products fall over the so-called waterfall, such that the products on the conveyor belt 7 are slowed down and piled up, such that the mutual spacing 3 thereof diminishes. In this way too, portions are obtained which exhibit the above-stated advantages.

A further piling-up option is shown in FIG. 4. The shaped, i.e. folded, food product slices 1 are conveyed by a conveyor belt 2 towards a conveying obstacle, in the present case a blocking rake 9, and slowed down and piled up in the process, such that the mutual spacing 3 diminishes and a portion is formed which exhibits the above-stated advantages. As soon as a portion is finished, the blocking rake 9 is swiveled in the direction 16 illustrated by the double-headed arrow, such that the portion may pass through and a new portion may be formed once the blocking rake has been returned to its vertical position.

### List of Reference Numerals

1 Food product slice
2 Conveyor belt
3 Spacing of the food product slices relative to one another
4 Means for shaping the food product slice
5 Means for changing the spacing between the food product slices
6 Cutting edge
7 Conveyor belt
8 Front end of the conveyor belt
9 Blocking rake
10 Camera
11 Food product block
12 Blade
13 Cutting plane
14, 15 Conveying direction
16 Double-headed arrow
V₁₄ Conveying speed of conveyor belt 2
V₁₅ Conveying speed of conveyor belt 7

1-17. (canceled)

18. A method of producing a food product portion, a plurality of food product slices (1) cut off from a block of sausage, cheese or ham (11) being shaped and deposited on a means (2) at a spacing (3) and conveyed away, characterised in that the food product slices (1) are then slowed down and piled up, such that the spacing (3) between the food product slices (1) is reduced.

19. A method according to claim 18, characterised in that the food product slices are folded and/or fluted.

20. A method according to claim 18, characterised in that the change in spacing during conveying of the food product slices (1) is brought about by changing the relative speed of two successive food product slices.

21. A device for producing food product portions, having a means (4) for shaping food product slices cut off from a block of sausage, cheese or ham (11), characterised in that it comprises a means (5) for changing the spacing (3) between the food product slices (1), wherein the means (5) slows down the food product slices (1) and piles them up.

22. A device according to claim 21, characterised in that the means (5) consists of a first and a second conveyor belt (2, 7), wherein the second conveyor belt (7) exhibits a slower conveying speed than the first conveyor belt (2) to reduce the spacing (3) between two food product slices (1).

23. A device according to claim 22, characterised in that the first belt (2) forms a conveying plane with the second belt or the end (8) of the first belt (2) is arranged above the second belt (7).

24. A device according to claim 21, characterised in that the means (5) is a conveying obstacle, preferably a blocking rake (9).

25. A device for slicing food product blocks, comprising a means (4) for changing the shape of a food product slice (1), at least one parameter of the means (4) being adjustable and the at least one parameter being the position of the means (4) relative to the cutting plane and/or relative to the food product slice (1) as it falls, adjustment of the parameter(s) taking place during operation of the device, preferably during slicing, characterised in that it comprises a detecting means (10), which detects at least one characteristic of the food product block (11) to be sliced and/or of the cut-off food product slices (1) and changes at least one parameter of the means (4) as a function thereof.

26. A device according to claim 25, characterised in that adjustment is effected by at least one actuator.

27. A device according to claim 25, characterised in that the device comprises a belt (2) on which the food product slices (1) are deposited and in that the position of the means (4) preferably remains unchanged relative to the belt (2).

28. A device according to claim 27, characterised in that the characteristic is the height of the food product block, the thickness of the food product slices, the type of food product and/or the temperature.

29. A method of severing food product slices (1) from food product blocks, the shape of the food product slice being changed by a means (4) after severing, at least one parameter of the means (4) being adjustable, the at least one parameter being the position of the means (4) relative to the cutting plane and/or relative to the slice as its falls, the at least one adjustable parameter of the means (4) being changed during slicing of the food product block, characterised in that a detecting means (10) detects at least one characteristic of the food product block (11) to be sliced and/or of the cut-off food product slices (1) and at least one parameter of the means (5) is changed as a function thereof.
